(19) United States
(12) Patent Application Publication
(10) Pub. No.: US 2006/0221501 A1
(43) Pub. Date: Oct. 5, 2006

(54) Slider, magnetic head assembly and manufacturing the same

(75) Inventors: Toshihiko Sato, Niigata-ken (JP); Ooki Yamaguchi, Niigata-ken (JP); Naruaki Oki, Niigata-ken (JP); Masayuki Obana, Niigata-ken (JP); Masayoshi Nakagawa, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/388,653

(22) Filed: Mar. 23, 2006

(30) Foreign Application Priority Data
Apr. 5, 2005 (JP) 2005-108432

(51) Int. Cl. G11B 5/60

(52) U.S. Cl. 360/234.5

(57) ABSTRACT

A slider includes electrode pads each of which is bonded to an electrode pad of a flexible printed circuit board through a solder ball. Surface cleaning is performed on the electrode pad of the slider in a vacuum atmosphere, and an Au surface protective film is formed on a new film surface of the same electrode pad. The entire surface of the same electrode pad is covered with the protective film. When the electrode pads of the slider and the flexible printed circuit board are bonded to each other by soldering, a solder ball is melted between the electrode pads, so that a solder fillet is formed in contact with the top surface of the electrode pad of the slider, side surfaces of the same electrode pad close to the flexible printed circuit board, and the top surface of the electrode pad of the flexible printed circuit board.

### BACKGROUND OF THE INVENTION

1. Field of the Invention

The present invention relates to a slider having an electrode pad which is bonded to an electrode pad of a flexible printed circuit board through a solder ball, a method of manufacturing the same, and a magnetic head assembly.

2. Description of the Related Art

A so-called magnetic head assembly used in a hard disc drive (HDD) includes a slider which is integrated with a mangnetoresistance effect element, a flexure which is made of a thin metal sheet having flexibility and elastically supports the slider, and a flexible printed circuit board which adheres to the surface of the flexure. The flexible printed circuit board electrically connects thin metal sheet elements (a magnetoresistance effect element, an inductive element, a thin metal sheet heater, a temperature sensor, etc.) of the slider, and a circuit system of a device having the magnetic head assembly mounted therein. The flexure is fixed on a load beam by means of, for example, spot welding.

In such a magnetic head assembly, an electrode pad of the slider is bonded to an electrode pad of the flexible printed circuit board by means of gold ball bonding, in a state in which they are disposed in a direction orthogonal to each other. However, recently, the magnetic head assembly and the slider have been made small in size, and a bonding region (size of the electrode pad or gap between the electrode pads) has been made narrow. Therefore, a method has been proposed, in which instead of using the gold ball bonding, solder ball bonding is used, considering that a solder ball can be formed with a smaller spherical diameter than the gold ball (see JP-A-10-79105 (U.S. Pat. No. 5,828,031) and JP-A-2003-30811 (see PAJ translation)).

The solder ball bonding method includes processes of fixing a solder ball on the electrode pad of the slider or the electrode pad of the flexible printed circuit board; heating the solder ball; and bonding the electrode pad of the slider and the electrode pad of the flexible printed circuit board by a melted solder. Generally, the electrode pad of the slider is formed of, for example, a Ni plating film, and a surface protective layer made of an Au plating film is continuously formed on the Ni plating film.

However, when the electrode pad of the slider and the surface protective layer thereof are continuously formed by means of plating, the surface of the electrode pad may unexpectedly oxidize and deteriorate after the electrode pad is formed and before the surface protective layer is formed. The deterioration of the surface partially involves in deteriorating the bonding strength between both electrode pads of the slider and the flexible printed circuit board. In addition, with the plating method, the surface protective layer is exclusively formed on the top surface of the electrode pad. Therefore, solder wettability is bad on the side of the electrode pad, and a solder fillet formed between both electrode pads of the slider and the flexible printed circuit board is fragile.

### SUMMARY OF THE INVENTION

The invention has been made to solve the above-described problems inherent in the related art, and it is an object of the invention to provide a slider in which both electrode pads of the slider and a flexible printed circuit board can be firmly bonded to each other through a solder ball, a method of manufacturing the same, and a magnetic head assembly.

According to a first aspect of the invention, there is provided a slider which includes electrode pads each of which is bonded to an electrode pad of a flexible printed circuit board through a solder ball. Further, the entire surface of each of the electrode pads of the slider is covered with an Au surface protective film formed in a vacuum atmosphere.

According to this aspect, since the solder wettability is improved not only at the tope surface of the electrode pad of the slider but also at the side surfaces thereof, when the electrode pad of the slider is bonded to the electrode pad of the flexible printed circuit board through the solder ball, a solder fillet is formed in contact with the top surface of the electrode pad of the slider, a side surface of the slider close to the flexible printed circuit board, and the top surface of the electrode pad of the flexible printed circuit board. Therefore, it is possible to improve the bonding strength between both electrode pads of the slider and the flexible printed circuit board. In addition, since the Au surface protective film has characteristic that prevents oxidization, the electrode pad that is covered with the Au surface protective film is prevented from deteriorating due to oxidization, and the bonding strength after the solder bonding is prevented from deteriorating as well.

Preferably, the electrode pad of the slider is formed of a Ni plating film or a NiFe plating film. Further, preferably, an adhesive layer, which is made of Ni, NiFe or NiCu formed in the vacuum atmosphere, is interposed between the surface of the electrode pad and the Au surface protective film. With the adhesive layer, adhesion between the surface of the electrode pad and the Au surface protective film is improved. Therefore, the bonding strength after the solder bonding can be enhanced.

According to a second aspect of the invention, there is provided a method of manufacturing a slider which includes electrode pads each of which is bonded to an electrode pad of a flexible printed circuit board through a solder ball. The method includes: performing surface cleaning on the electrode pad of the slider in a vacuum atmosphere; forming an Au surface protective film on a new film surface of the electrode pad exposed by the surface cleaning, in the same vacuum atmosphere; and covering the entire surface of the electrode pad of the slider with the Au surface protective film.

According to a third aspect of the invention, there is provided a method of manufacturing a slider which includes electrode pads each of which is bonded to an electrode pad of a flexible printed circuit board through a solder ball. The method includes: performing surface cleaning on the electrode pad of the slider in the vacuum atmosphere; forming an adhesive layer, made of Ni, NiFe or NiCu, on a new film surface of the electrode pad exposed by the surface cleaning, in the same vacuum atmosphere, and forming an Au surface protective film on the adhesive layer so as to cover the entire surface of the electrode pad of the slider with the adhesive layer and the Au surface protective film.

According to a fourth aspect of the invention, there is provided a magnetic head assembly. The magnetic head assembly includes: a slider that includes electrode pads each of which applies a current to a thin film element and is bonded to an electrode pad of a flexible printed circuit board through a solder ball. Further, a solder fillet is formed in contact with the top surface of the electrode pad of the slider, the side surfaces of the corresponding electrode pad close to the flexible printed circuit board, and the top surface of the electrode pad of the flexible printed circuit board.

According to the aspects of the invention, it is possible to obtain a slider in which both electrode pads of the slider and the flexible printed circuit board can be firmly bonded to each other through the solder ball, a method of manufacturing the same, and a magnetic head assembly.

### BRIEF DESCRIPTION OF THE DRAWINGS

FIG. 1 is a schematic view showing a slider and a magnetic head assembly (completed state) including the slider according to an embodiment of the invention;

FIG. 2 is an enlarged view schematically showing bonded portions between an electrode pad of the slider of FIG. 1 and an electrode pad of a flexible printed circuit board;

FIG. 3 is a cross-sectional view showing the electrode pad of the slider and the electrode pad of the flexible printed circuit board before solder bonding;

FIG. 4 is a cross-sectional view schematically illustrating one process of a solder ball bonding method between the electrode pad of the slider and the electrode pad of the flexible printed circuit board;

FIG. 5 is a cross-sectional view showing the electrode pad of the slider and the electrode pad of the flexible printed circuit board after solder bonding; and

FIG. 6 is a cross-sectional view showing a state in which an adhesive layer is interposed between a surface of the electrode pad of the slider and an Au surface protective film.

### DESCRIPTION OF THE PREFERRED EMBODIMENT

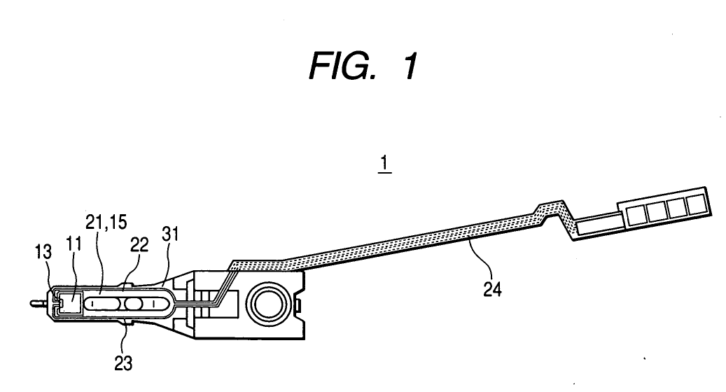

FIG. 1 is a schematic view showing a slider and a hard disc drive magnetic head assembly (completed state) including the slider according to a first embodiment of the invention. A magnetic head assembly 1 includes a slider 11 that is integrated with thin film elements, and a flexure 21 that adheres to the rear surface of the slider 11 by means of adhesives, such as a thermosetting adhesive, an ultraviolet (UV) curing adhesive, and a conductive adhesive. The thin film elements integrated with the slider 11 of the present embodiment correspond to a magnetoresistance effect element serving as a reproducing element, and an inductive element serving as a recording element.

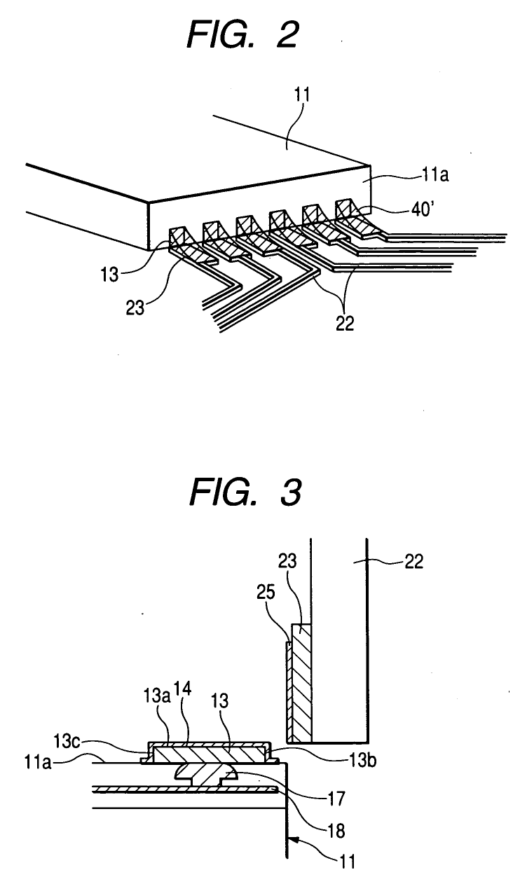

The flexure 21 is a thin metal sheet that is formed in a leaf spring and has flexibility. The flexure 21 is mounted on a leading end of a load beam 15 while elastically supporting the slider 11 such that the slider 11 floats with respect to the load beam 15. A flexible printed circuit board (FPC) 22 adheres to the surface of the flexure 21 by means of adhesives. The flexible printed circuit board 22 electrically connects the thin film element of the slider 11 and a circuit system of a hard disk device having the magnetic head assembly 1 mounted therein. The flexible printed circuit boards 22, as enlargedly shown in FIG. 2, are extended from a plurality of electrode pads 23 disposed on the leading end of the flexure 21, then are divided into both sides of the electrode pads 23, then are extended along both sides, then are led from trailing sides of the flexure 21, and then are collected as one flexible circuit board through a relay flexible printed circuit board 24. The relay flexible printed circuit board 24 is connected to the circuit system of the hard disk device having the magnetic head assembly 1 mounted therein. The slider 11 has a plurality of electrode pads 13 connected to the thin film elements, and is mounted on the flexure 21 in a state in which the electrode pads 13 and the electrode pads 23 of the FPC 22 are disposed in a direction perpendicular to each other.

Each of the electrode pads 13 of the slider is formed of a Ni plating film formed on an end face 11a of the slider 11, and is connected to a lead conductor 18 of the thin film element through a bump 17. The electrode pad 13, as shown in FIG. 3, is covered with an Au surface protective film 14 over the entire surface (top surface 13a and both side surfaces 13b and 13c) and not exposed to the outside, in a state before the electrode pad 13 is soldered to the electrode pad 23 of the FPC 22. The Au surface protective film 14 is a protective film that is formed on a new film surface of the electrode pad 13 being exposed by surface cleaning after a surface oxidized film of the electrode pad 13 (Ni plating film) is removed by the surface cleaning in a vacuum atmosphere. The Au surface protective film 14 involves preventing the surface of the electrode pad 13 from deteriorating (oxidization) and in improving the solder wettability of the electrode pad 13. A sputtering method and a deposition method are used in forming the Au surface protective film 14.

The electrode pad 23 of the FPC 22 is formed of a conductor pattern made of Cu, and an Au plating film 25 is formed on the surface of the electrode pad 23.

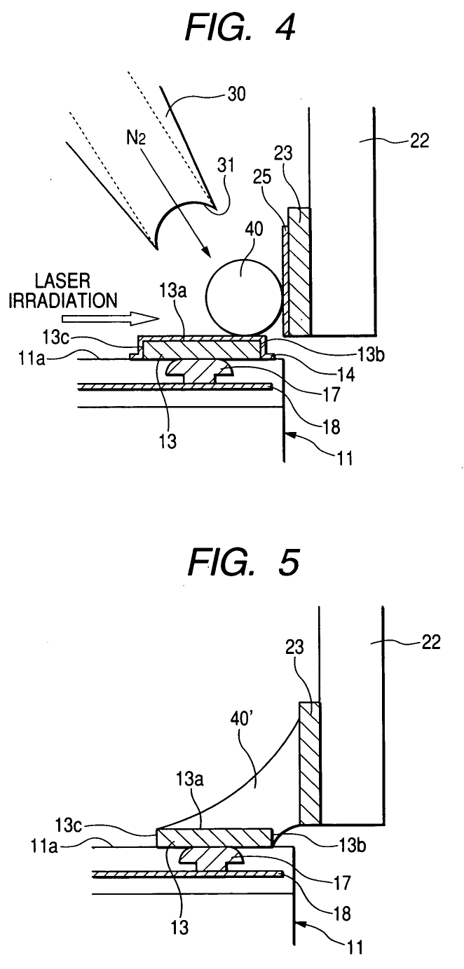

The electrode pad 13 of the slider 11 and the electrode pad 23 of the FPC 22 are bonded to each other by means of a solder ball bonding (SBB) method. The bonding by means of the solder ball bonding method is performed as follows. First, as shown in FIG. 4, by using a capillary 30 and nitrogen gas blow N₂ which flows inside the capillary 30, a spherical solder ball 40 is applied between the electrode pad 13 of the slider 11 and the electrode pad 23 of the FPC 22, and a laser beam is irradiated onto portions of the solder ball 40 so as to temporarily fix the solder ball. The temporary fixation is performed in a state in which the solder ball 40 is positioned by pressure of the nitrogen gas blow N₂ coming from an outlet 31 of the capillary 30. The solder ball 40 is made of a solder material having tin as main components excluding lead, and is formed with the diameter of 80 to 130 μm. Then, by supplying nitrogen gas blow N₂ through the capillary 30, a laser beam is irradiated again onto the solder ball 40 that is temporarily fixed, so that the solder ball 40 is all melted.

The melted solder spreads over the Au surface protective film 14 that covers the entire surface of the electrode pad 13 of the slider 11 and the Au plating film 25 that covers the surface of the electrode pad 23 of the FPC 22 and gets them drenched with the solder, and then is solidified again over the electrode pad 13 of the slider 11 and the electrode pad 23 of the FPC 22. In the present embodiment, since the Au surface protective film 14 is formed not only on the top surface 13a of the electrode pad 13 of the slider 11 but also on the side surfaces 13b and 13c thereof, the melted solder flows into the side surface 13b of the electrode pad 13 that is close to the FPC 22. Specifically, as shown in FIG. 5, a solder fillet 40′ is formed in contact with three surfaces, that is, the top surface 13a of the electrode pad 13 of the slider 11, the side surface 13b of the electrode pad 13 close to the FPC 22, and the top surface of the electrode pad 23 of the FPC 22. In this way, with the solder reaching up to the side surface 13b of the electrode pad 13 of the slider 11, the bonding strength is enhanced, as compared to the related art in which solder is in contact with only the top surface 13a of the electrode pad 13 of the slider 11 and the top surface of the electrode pad 23 of the FPC 22. In addition, the Au surface protective film 14 and the Au plating film 25 are mixed with the melted solder and become a part of a solder fillet 40′, thus the Au surface protective film 14 and the Au plating film 25 do not remain as a single body after solder bonding.

As described above, according to the present embodiment, since the entire surface of the electrode pad 13 of the slider 11 is covered with the Au surface protective film 14 that is formed in the vacuum atmosphere, the solder wettability of the electrode pad 13 of the slider 11 is excellent over the entire surface (top surface 13a and side surfaces 13b and 13c). Therefore, when the solder ball 40 is melted between both electrode pads 13 and 23 of the slider 11 and the FPC 22, the solder fillet 40′ is formed in contact with the top surface 13a of the electrode pad 13 of the slider 11, the top surface of the electrode pad 23 of the FPC 22, and the side surface 13b of the electrode pad 13 close to the FPC 22. With the solder fillet 40′, both electrode pads 13 and 23 of the slider 11 and the FPC 22 can be firmly bonded to each other. In addition, when the Au surface protective film 14 is formed in the vacuum atmosphere, the surface cleaning can be performed on the electrode pad 13 in the same vacuum atmosphere before forming the Au surface protective film 14, and the Au surface protective film 14 is formed on a new film surface of the electrode pad 13 that is not polluted by the surface cleaning. Therefore, it is possible to improve the bonding strength of soldering with the electrode pad 13 of the slider 11.

In the present embodiment, there is provided with the slider 11 which is constructed by integrating a mangnetoresistance effect element (reproducing element) and an inductive element (recording element) as thin film elements. However, the thin film elements integrated with the slider may include thin film functional elements, such as a thin film heater element and a thin film temperature sensor element, in addition to the magnetoresistance effect element and the inductive element. That is, the electrode pad 13 of the slider 11 is an electrode pad for allowing currents to flow to the thin film elements, and any type of thin film element may be used.

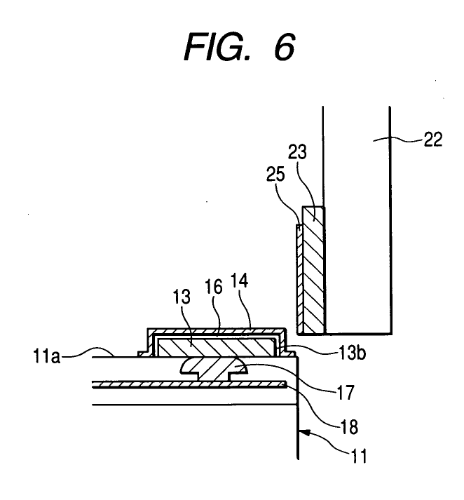

Even though the Au surface protective film 14 is directly formed on the electrode pad 13 of the slider 11 in the present embodiment, as shown in FIG. 6, an adhesive layer 16 made of Ni, NiFe or NiCu may be interposed between the electrode pad 13 of the slider 11 and the Au surface protective film 14. The adhesive layer 16 and the Au surface protective film 14 cover the entire surface of the electrode pad 13 of the slider 11 before the solder bonding, and the Au surface protective film 14 does not remain as a single body and becomes a part of the solder fillet 40′ after the solder bonding, and then only the adhesive layer 16 remains. Before forming the Au surface protective film 14 after performing the surface cleaning on the electrode pad 13, the adhesive layer 16 may be formed on a new film surface of the electrode pad 13 in the same vacuum atmosphere. With the adhesive layer 16, the adhesion between the electrode pad 13 of the slider 11 and the Au surface protective film 14 is improved; therefore, the bonding strength of soldering in the electrode pad 13 can be enhanced.

1. A slider comprising:
electrode pads each of which is bonded to an electrode pad of a flexible printed circuit board using a solder ball,
wherein the entire surface of each of the electrode pads of the slider is covered with an Au surface protective film formed in a vacuum atmosphere.

2. The slider according to claim 1,
wherein each of the electrode pads of the slider is formed of an Ni plating film or an NiFe plating film, and
an adhesive layer, which is made of Ni, NiFe or NiCu formed in the vacuum atmosphere, is interposed between the surface of the electrode pad and the Au surface protective film.

3. A method of manufacturing a slider, the slider including electrode pads each of which is bonded to an electrode pad of a flexible printed circuit board using a solder ball, the method comprising:
performing surface cleaning on the electrode pad of the slider in a vacuum atmosphere;
forming an Au surface protective film on a new film surface of the electrode pad exposed by the surface cleaning, in the same vacuum atmosphere; and
covering the entire surface of the electrode pad of the slider with the Au surface protective film.

4. A method of manufacturing a slider, the slider including electrode pads each of which is bonded to an electrode pad of a flexible printed circuit board using a solder ball, the method comprising:
performing surface cleaning on the electrode pad of the slider in a vacuum atmosphere; and
forming an adhesive layer, made of Ni, NiFe or NiCu, on a new film surface of the electrode pad exposed by the surface cleaning, in the same vacuum atmosphere, and
forming an Au surface protective film on the adhesive layer so as to cover the entire surface of the electrode pad of the slider with the adhesive layer and the Au surface protective film.

5. A magnetic head assembly comprising:
a slider that includes electrode pads each of which applies a current to a thin film element and is bonded to an electrode pad of a flexible printed circuit board using a solder ball,
wherein a solder fillet is formed in contact with the top surface of the electrode pad of the slider, the side surfaces of the corresponding electrode pad close to the flexible printed circuit board, and the top surface of the electrode pad of the flexible printed circuit board.
